(19) United States
(12) Patent Application Publication
(10) Pub. No.: US 2005/0187911 A1
(43) Pub. Date: Aug. 25, 2005

(54) Visual query

(75) Inventor: Brian R. Tunning, San Francisco, CA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/786,453

(22) Filed: Feb. 24, 2004

(51) Int. Cl. G06F 7/00

(52) U.S. Cl. 707/3

(57) ABSTRACT

In an implementation of visual query, a visual query definition associates query criteria in a display. A query statement association is determined for each display relationship of the query criteria and a query statement is generated for each of the query criteria. The query statements are combined according to the query statement associations and a query result of the combined query statements is generated for display in the visual query definition.

### TECHNICAL FIELD

This invention relates to visual query.

### BACKGROUND

The Structured Query Language (SQL) is a programming language that can be used to update, select, insert, and obtain data from a database or relational databases with defined SQL queries. Transact-SQL (TSQL) is a command language that adds features to SQL by which client devices can interact with SQL servers to retrieve and manipulate data maintained with a SQL server or database.

Current systems for creating SQL queries allow a user to write query expressions in English with Boolean logical operators (e.g., AND, OR, and the like) and perform a conversion of the written query expressions into a valid Boolean SQL query. Other systems allow a user to create a graphical representation of a query on a grid display utilizing logic connectors and operators to define relationships between query data. However, written query expressions and graphical representations of queries require a user to know complicated SQL query statement syntax, and graphical representations of queries are difficult to develop on a grid display because the graphical representations are too structured.

For example, traditional query design interfaces require a user to have a working knowledge of how the underlying database is designed and constructed which limits a user's ability to quickly develop an ad-hoc query about the data in the database. Traditional query design interfaces are designed such that a user selects the fields, tables, and data to include in a query, and then manually adds filters to the fields by inputting query constructs. A user needs to know beforehand the query criteria to include or exclude, as well as know the query language to express that information.

### SUMMARY

Visual query is described herein.

In an implementation, a visual query definition associates query criteria in a display. A query statement association is determined for each display relationship of the query criteria and a query statement is generated for each of the query criteria. The query statements are combined according to the query statement associations and a query result of the combined query statements is generated for display in the visual query definition.

### BRIEF DESCRIPTION OF THE DRAWINGS

The same numbers are used throughout the drawings to reference like features and components.

FIG. 1 illustrates an exemplary embodiment of visual query.

FIG. 2 illustrates various components of a computing system in which an exemplary embodiment of visual query can be implemented.

FIG. 3 illustrates an exemplary embodiment of visual query.

FIG. 4 illustrates an exemplary embodiment of visual query.

FIG. 5 illustrates an exemplary embodiment of visual query.

FIG. 6 illustrates an exemplary embodiment of visual query.

FIG. 7 is a flow diagram that illustrates an exemplary method for an embodiment of visual query.

FIG. 8 illustrates exemplary computing systems, devices, and components in an environment that visual query can be implemented.

### DETAILED DESCRIPTION

Visual query is described which provides a user interface by which a user can construct a query by placing or defining shapes that represent query criteria onto a design surface. The positioning of the shapes in relation to each other describes the query and defines the associations between query criteria, and the layout of the shapes is translated into T-SQL statements. This allows a user to create queries to access a database or relational databases without having to know complicated SQL query statement syntax for written SQL queries and graphical representations of queries on grid displays. Making use of existing database data assists a user when constructing a query and is one feature of visual query that departs from the traditional query design interfaces, and which provides users without extensive knowledge of a database structure to effectively build queries.

The following discussion is directed to systems and methods for visual query. While features of the described systems and methods can be implemented in any number of different computing environments and application programs, they are described in the context of the following exemplary implementations.

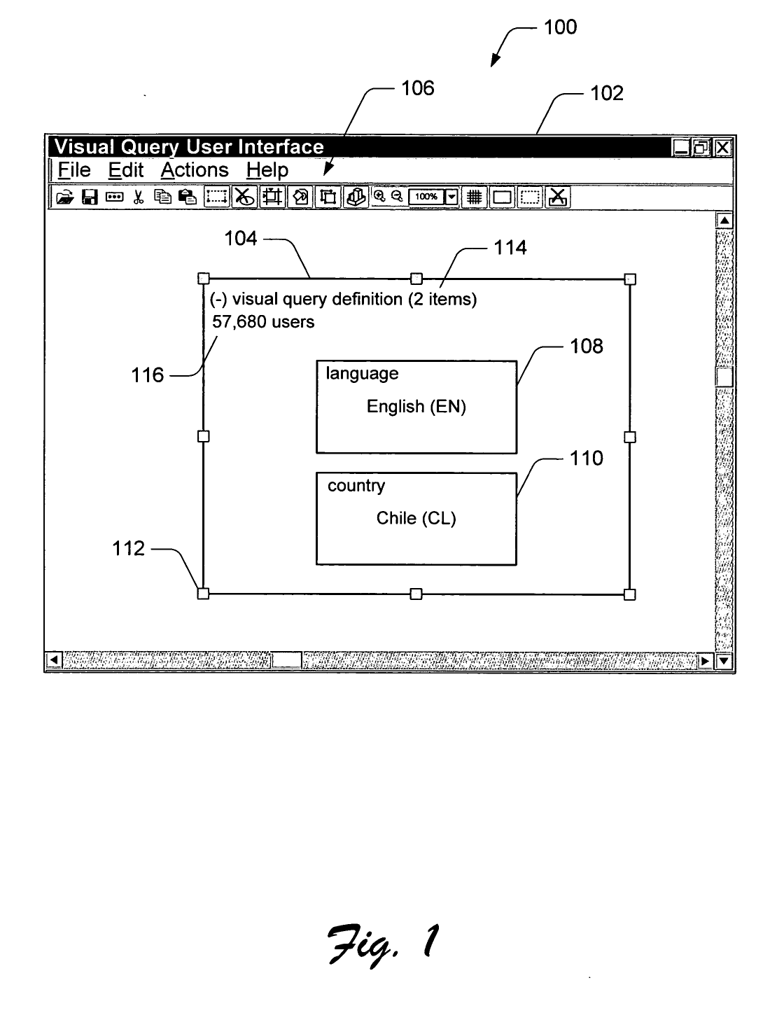

FIG. 1 illustrates an exemplary embodiment of a visual query 100. In this example, a visual query user interface 102 includes a visual query definition 104 and any number of selectable controls 106 which may be included in a context menu, a menu bar, and/or a tool bar on the visual query user interface 102. The visual query definition 104 includes query criteria 108 and 110 which are displayed as shapes (e.g., rectangles in this example) that have a semantic relationship such that the display position of the shapes of query criteria 108 and 110 defines a query statement association for the shapes. For example, in an embodiment, query criteria 108 and 110 have an AND Boolean association corresponding to the proximate display of the shapes of query criteria 108 and 110 within the visual query definition 104.

The proximate display of the shapes of query criteria 108 and 110 defines a semantic relationship which is an intuitive way to represent query statement associations for the shapes. The query criteria 108 and 110 have an implied relationship that defines an association between the query criteria based on the proximate positioning of the query criteria. Further, the implied or intuitive relationship of the query criteria is established without logical connectors or operators connected between the query criteria within the visual query definition 104.

The visual query definition 104 can be moved and/or resized with side and edge controllers 112 (also commonly referred to as “grippers”). The visual query definition 104 can also include identifying information 114, such as an indication that the visual query definition 104 includes two items of query criteria 108 and 110. The visual query definition 104 can also include a query result 116 which, in this example, is the number of users that speak the English language (i.e., query criteria 108) AND live in the country Chile (i.e., query criteria 110).

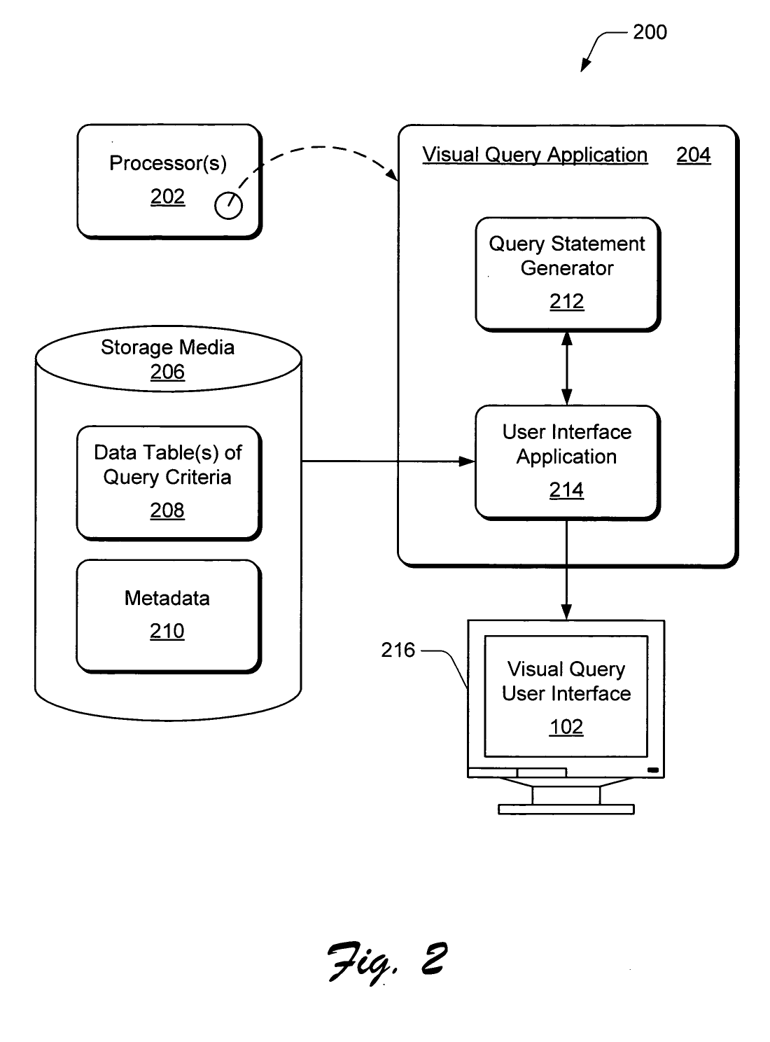

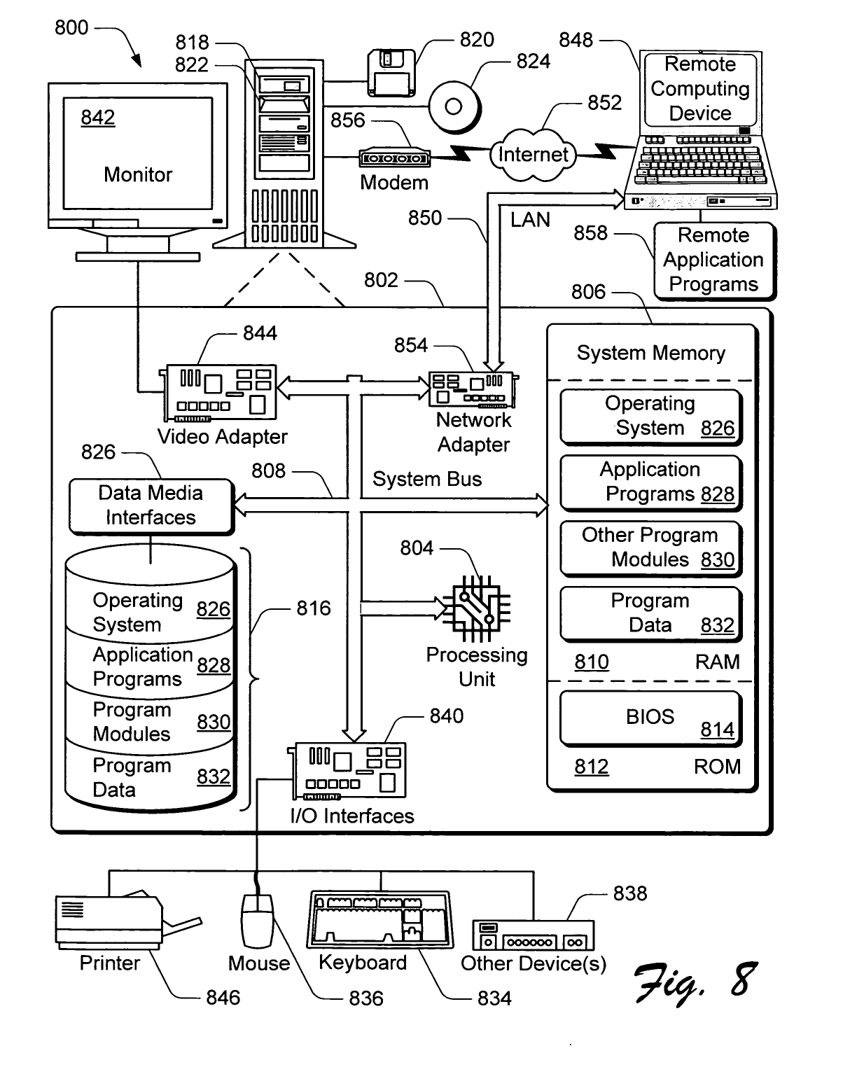

FIG. 2 illustrates various components of a computing system 200 in which an exemplary embodiment of visual query can be implemented. The computing system 200 includes one or more processors 202 (e.g., any of microprocessors, controllers, and the like) which execute a visual query application 204 and process instructions to control the operation of various components for visual query. The computing system 200 can be implemented with one or more memory components, such as any form of storage media 204. Although not shown in this example, the computing system 200 may be implemented with any number and combination of differing components as further described below with reference to the exemplary computing systems, devices, and components shown in FIG. 8.

The storage media 204 can be implemented as any form of a database or relational database having data which can be manipulated and/or retrieved with any form of a query or SQL query. In this example, storage media 204 maintains data tables of query criteria 208 and metadata 210. In an embodiment, the data tables of query criteria 208 are SQL database tables having fields of query criteria.

The metadata 210 correlates to the query criteria in the data tables 208 and is used to display the query criteria in user-identifiable terms on a visual query user interface, such as the visual query user interface 102 shown in FIG. 1. The metadata 210 expresses the query criteria by name rather than by identifier and describes the relation between the query criteria names and the identifiers which defines a relation to the actual data maintained in the data table(s) 208. The metadata 210 is also utilized to construct the actual query issues to the storage media 206 (e.g., a SQL database server).

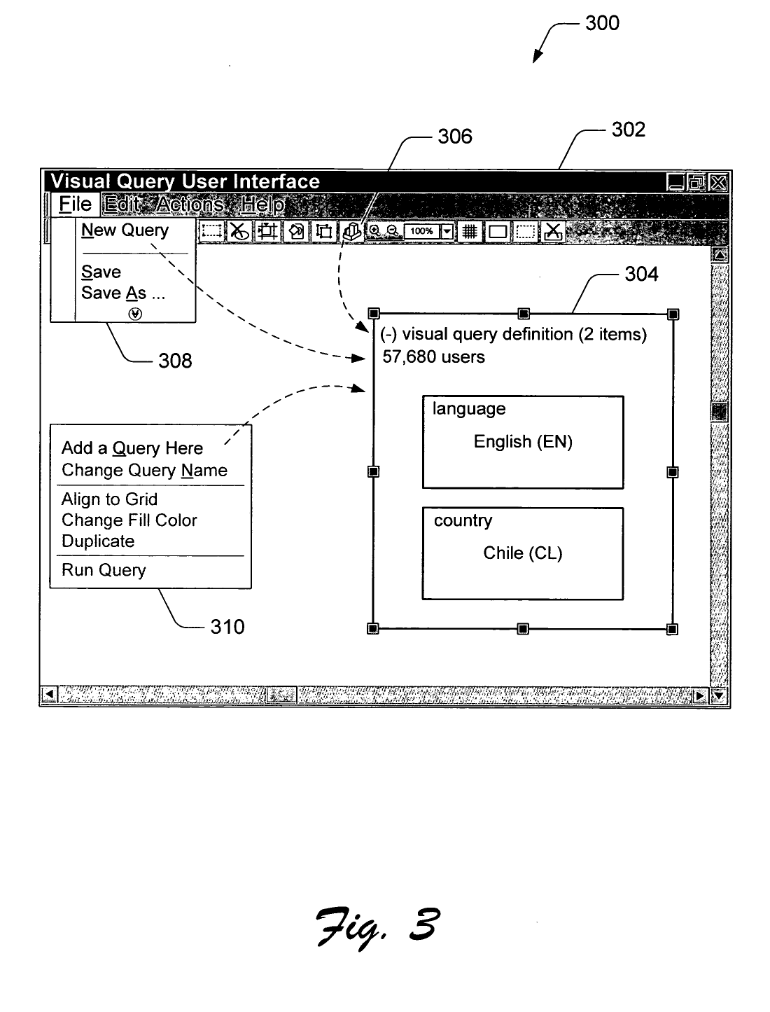

The visual query application 204 includes a query statement generator 212 and a user interface application 214. The user interface application 214 generates a visual query user interface for display on a display device 216. For example, the user interface application 214 generates the visual query user interface 102 shown in FIG. 1, as well as the other exemplary visual query user interfaces described with reference to FIGS. 3 through 6.

The query statement generator 212 can be implemented to perform various functions of visual query. For example, the query statement generator 212 determines a query statement association for each display relationship of query criteria in a visual query definition, such as a display relationship between query criteria 108 and 110 within visual query definition 102 shown in FIG. 1. In an embodiment, the display relationship of the shapes of query criteria 108 and 110 can be determined as an AND Boolean association that corresponds to the semantic relationship of the shapes (e.g., the shapes are displayed to have an intuitive relationship to a user based on the shapes proximate positioning without logic connectors or operators connecting the query criteria).

The query statement generator 212 also generates a query statement for each shape of query criteria and combines the query statements according to the query statement associations (e.g., Boolean operators AND, OR, and the like). For the example shown in FIG. 1, a SQL query is generated that compiles to “select*from users where language=‘EN’ AND country=‘CL’”. The query statement generator 212 also generates the query result 116 of the combined query statements for display in the visual query definition 104.

Although the query statement generator 212 and the user interface application 214 are each illustrated and described as single and separate modules or application programs of the visual query application 204, each of the application programs can be implemented as several component applications distributed to each perform one or more functions of a visual query. Further, although the query statement generator 212 and the user interface application 214 are illustrated and described as separate application programs, the application programs can be implemented together as a single application program, such as a single visual query application 204.

FIG. 3 illustrates an exemplary embodiment of a visual query 300 that includes a visual query user interface 302 on which a visual query definition 304 is displayed. The visual query definition 304 can be initiated with a user selectable control 306 on a user interface toolbar, or can be initiated from a menu bar 308 or from a context menu 310.

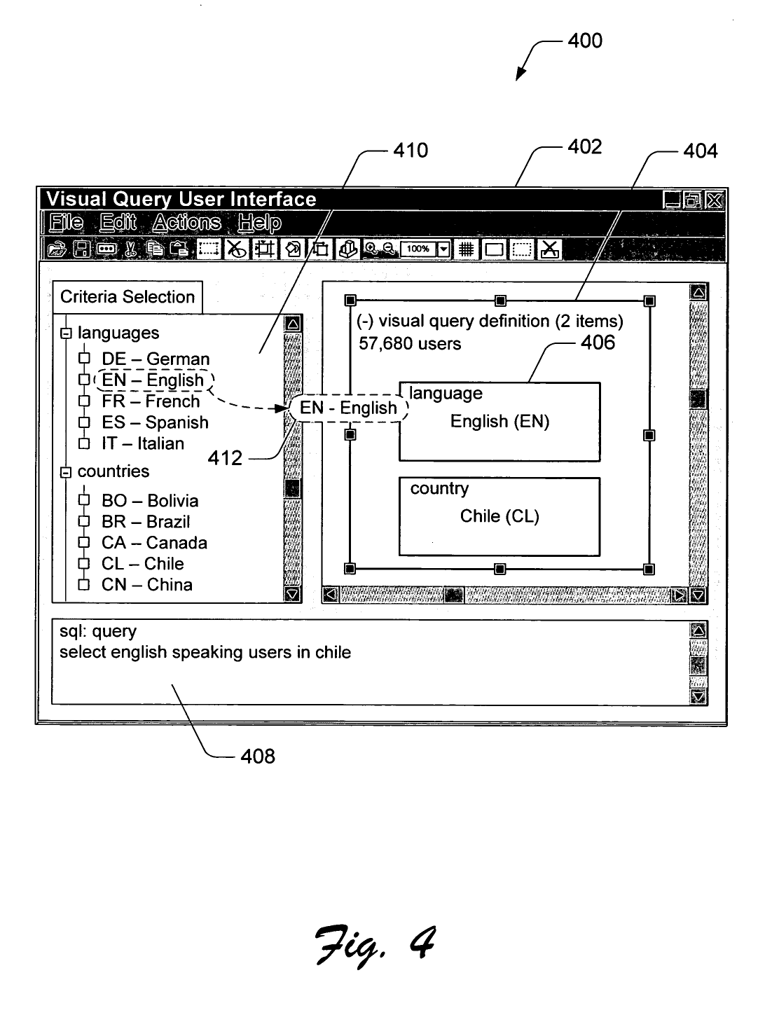

FIG. 4 illustrates an exemplary embodiment of a visual query 400 that includes a visual query user interface 402 on which a visual query definition 404 is displayed. The visual query definition 404 includes query criteria, such as a shape of query criteria 406 (e.g., a rectangle in this example). The visual query user interface 402 also includes an output display 408 in which user feedback information that corresponds to the visual query definition 404 can be displayed. The visual query user interface 402 also includes a criteria selection display 410 from which a user can drag-and-drop query criteria 406 from the criteria selection display 410 to the visual query definition 404, as shown at 412. The query criteria (e.g., query criteria 406) is provided for a user who does not have to know beforehand what the query criteria is and how it is organized when maintained in a server database.

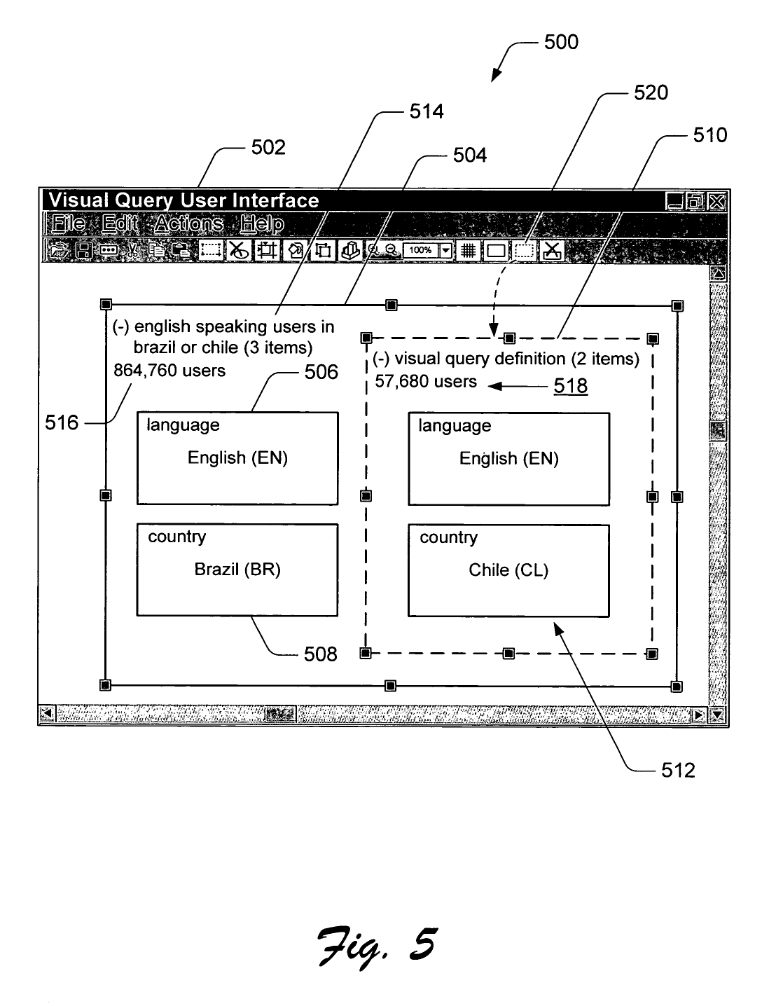

FIG. 5 illustrates an exemplary embodiment of a visual query 500 that includes a visual query user interface 502 on which a visual query definition 504 is displayed. The visual query definition 504 includes query criteria 506 and 508, as well as another visual query definition 510 which also includes various query criteria 512. The visual query definition 504 includes a textual indication 514 of the query and a query result 516. The textual indication 514 of visual query definition 504 identifies the query as “English speaking users in Brazil or Chile”, and the query result 516 is generated and displayed to indicate the number of such users. The visual query definition 510 also includes a query result 518 which can be updated and displayed along with query result 516. The query result 518 of visual query definition 510 is also generated and displayed to indicate only the number of users corresponding to “English speaking users in Chile”.

In this example, visual query definition 510 is bordered with a visual indication (e.g., a dashed border line) that query criteria 512 has an OR Boolean association with query criteria 506 and 508 within the visual query definition 504. A visual query definition can also be defined with user-selectable control 520, for example, to have an OR Boolean association with another visual query definition and/or other query criteria. In an embodiment, a user can execute selected queries only, or all of the queries defined on a display. Further, visual query definition 510 can be created with a copy-and-paste operation. For example, visual query definition 504 can be copied and pasted on the visual query user interface 502 as a new query 510 which may also be implemented as a “shortcut” of visual query definition 504.

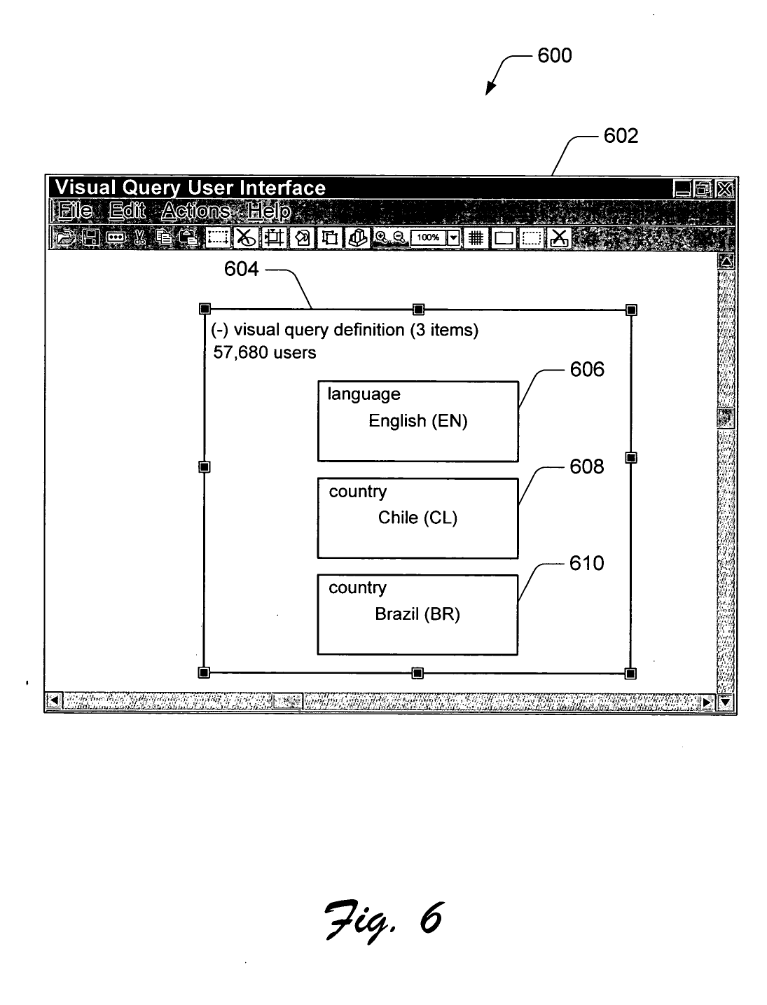

FIG. 6 illustrates an exemplary embodiment of a visual query 600 that includes a visual query user interface 602 on which a visual query definition 604 is displayed. The visual query definition 604 includes query criteria 606, 608, and 610 that each have a display relationship within the visual query definition 604. The query statement generator 212 (FIG. 2) determines a query statement association for each display relationship of the query criteria 606, 608, and 610.

In an embodiment, the display relationship and content of the query criteria defines the query statement associations. A first shape of query criteria displayed proximate a second shape of query criteria has an AND Boolean association with the second shape of query criteria. However, a first shape of query criteria displayed proximate a second shape of query criteria that are both of the same category have an OR Boolean association. In this example, the query criteria 608 and 610 are of the same category, “country”, and the query would be defined as “English speaking AND [Chile OR Brazil]” because there would not be an instance of an English speaking user living in both Chile and Brazil at the same time.

The query statement generator 212 generates a query statement for each of the query criteria: “language=‘EN’” (query criteria 606); “country=‘CL’” (query criteria 608); and “country=‘BR’” (query criteria 610). The query statement generator 212 also combines the query statements according to the query statement associations (optionally as default Boolean associations). In this example, the query statements would be combined as “language=‘EN’ AND country=‘CL’ OR country=‘BR’” which is then interpreted or translated as “English speaking users in Brazil or Chile”.

Although the query statement associations described herein only reference Boolean AND and OR operators, any Boolean or other logic operators can be implemented by the query statement generator 212 to combine query statements. Further, although a visual query definition is described as having a border that defines the query statement association between proximate query criteria in the visual query definition, any number of other visual identifiers can be utilized to describe the query statement associations, such as by using different colors, shapes, line styles, shading levels, audio feedback, and the like, any of which may also be user-definable.

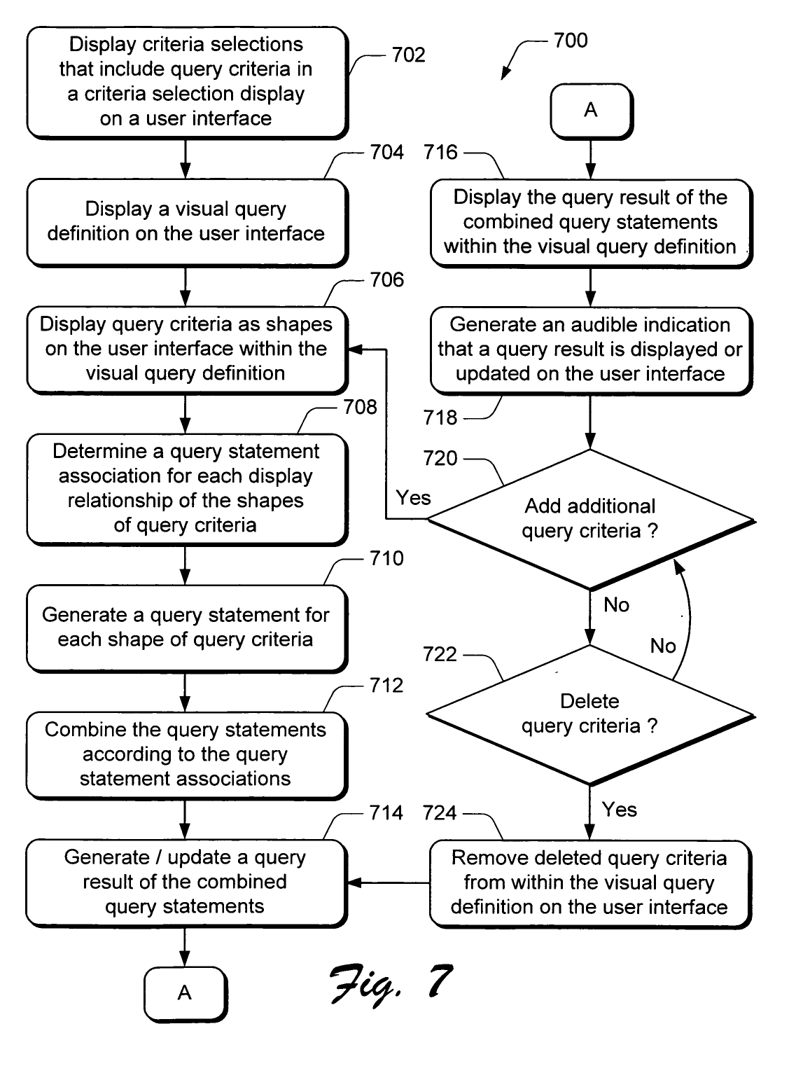

Methods for visual query, such as exemplary method 700 described with reference to FIG. 7, may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 7 illustrates an exemplary method 700 for an embodiment of a visual query. The order in which the method is described is not intended to be construed as a limitation, and any number of the described method blocks can be combined in any order to implement the method. Furthermore, the method can be implemented in any suitable hardware, software, firmware, or combination thereof.

At block 702, criteria selections are displayed that include query criteria in a criteria selection display on a user interface. For example, query criteria is displayed for user selection in the criteria selection display 410 on visual query user interface 402 (FIG. 4). The query criteria is displayed in user-identifiable terms as metadata 210 that correlates to data criteria maintained in data tables 208 on a database server 206 (FIG. 2). At block 704, a visual query definition is displayed on the user interface. For example, visual query definition 104 is displayed on the visual query user interface 102 (FIG. 1).

At block 706, query criteria are displayed as shapes on the user interface within the visual query definition. For example, query criteria 108 and 110 are displayed as rectangular shapes within the visual query definition 104 (FIG. 1). In an embodiment, a first shape of query criteria 108 is displayed proximate a second shape of query criteria 110 within a visual query definition 104 such that the first shape 108 has a Boolean association with the second shape 110. For example, the first shape may have an AND Boolean association with the second shape, or the first shape may have an OR Boolean association with the second shape. Further, a visual query definition 510 (FIG. 5) can be bordered to define a Boolean association between a first shape and the second shape. In another embodiment, a first set of query criteria 506 and 508 is displayed within a first visual query definition 504, and a second set of query criteria 512 is displayed within a second visual query definition 510 such that the first visual query definition 504 includes the second set of query criteria 512.

At block 708, a query statement association is determined for each display relationship of the shapes of query criteria. For example, query statement generator 212 (FIG. 2) determines a query statement association for a display relationship between query criteria 108 and 110 (FIG. 1) within visual query definition 102. In an embodiment, the display relationship of the shapes of query criteria 108 and 110 can be determined as an AND Boolean association that corresponds to the semantic relationship of the shapes.

At block 710, a query statement is generated for each shape of query criteria. At block 712, the query statements are combined according to the query statement associations. For example, query statement generator 212 (FIG. 2) generates a SQL or T-SQL query statement for each shape of query criteria 108 and 110 (FIG. 1), and combines the query statements according to the query statement associations (e.g., Boolean operators AND, OR, and the like).

At block 714, a query result of the combined query statements is generated, and at block 716, the query result of the combined query statements is displayed within the visual query definition. For example, query result 116 is generated and displayed within visual query definition 104 (FIG. 1). At block 718, an audible indication is generated that corresponds to a display of a query result on the user interface, or to an update of a query result displayed on the user interface.

At block 720, a determination is made as to whether additional query criteria is to be added as a shape on the user interface. In an embodiment, additional query criteria can be added by a user dragging-and-dropping the additional query criteria from the criteria selection display onto the user interface. If additional query criteria is to be added (i.e., “yes” from block 720), then the additional query criteria is displayed as a shape within the visual query definition at block 706. The method continues to determine an additional query statement association for a display relationship of the additional shape of query criteria (at block 708), an additional query statement corresponding to the additional shape of query criteria is generated (at block 710), the query statements and the additional query statement are combined according to the additional query statement association (at block 712), and the query result displayed on the user interface is updated to include the additional query criteria (at block 714).

If additional query criteria is not added (i.e., “no” from block 720), then a determination is made as to whether query criteria is deleted from the visual query at block 722. If query criteria is deleted from the visual query definition (i.e., “yes” from block 722), then the shape of query criteria is deleted from the visual query definition on the user interface at block 724 and the query result displayed in the visual query definition is updated at block 714.

FIG. 8 illustrates an exemplary computing environment 800 within which visual query systems and methods, as well as the computing, network, and system architectures described herein, can be either fully or partially implemented. Exemplary computing environment 800 is only one example of a computing system and is not intended to suggest any limitation as to the scope of use or functionality of the architectures. Neither should the computing environment 800 be interpreted as having any dependency or requirement relating to any one or combination of components illustrated in the exemplary computing environment 800.

The computer and network architectures in computing environment 800 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 800 includes a general-purpose computing system in the form of a computing device 802. The components of computing device 802 can include, but are not limited to, one or more processors 804 (e.g., any of microprocessors, controllers, and the like), a system memory 806, and a system bus 808 that couples the various system components. The one or more processors 804 process various computer executable instructions to control the operation of computing device 802 and to communicate with other electronic and computing devices. The system bus 808 represents any number of several types of bus structures, including a memory bus or memory controller, a peripheral bus, an accelerated graphics port, and a processor or local bus using any of a variety of bus architectures.

Computing environment 800 includes a variety of computer readable media which can be any media that is accessible by computing device 802 and includes both volatile and non-volatile media, removable and non-removable media. The system memory 806 includes computer-readable media in the form of volatile memory, such as random access memory (RAM) 810, and/or non-volatile memory, such as read only memory (ROM) 812. A basic input/output system (BIOS) 814 maintains the basic routines that facilitate information transfer between components within computing device 802, such as during start-up, and is stored in ROM 812. RAM 810 typically contains data and/or program modules that are immediately accessible to and/or presently operated on by one or more of the processors 804.

Computing device 802 may include other removable/non-removable, volatile/non-volatile computer storage media. By way of example, a hard disk drive 816 reads from and writes to a non-removable, non-volatile magnetic media (not shown), a magnetic disk drive 818 reads from and writes to a removable, non-volatile magnetic disk 820 (e.g., a “floppy disk”), and an optical disk drive 822 reads from and/or writes to a removable, non-volatile optical disk 824 such as a CD-ROM, digital versatile disk (DVD), or any other type of optical media. In this example, the hard disk drive 816, magnetic disk drive 818, and optical disk drive 822 are each connected to the system bus 808 by one or more data media interfaces 826. The disk drives and associated computer readable media provide non-volatile storage of computer readable instructions, data structures, program modules, and other data for computing device 802.

Any number of program modules can be stored on the hard disk 816, magnetic disk 820, optical disk 824, ROM 812, and/or RAM 810, including by way of example, an operating system 826, one or more application programs 828, other program modules 830, and program data 832. Each of such operating system 826, application programs 828, other program modules 830, and program data 832 (or some combination thereof) may include an embodiment of the systems and methods described herein.

Computing device 802 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, other wireless media, and any combination thereof.

A user can interface with computing device 802 via any number of different input devices such as a keyboard 834 and pointing device 836 (e.g., a “mouse”). Other input devices 838 (not shown specifically) may include a microphone, joystick, game pad, controller, satellite dish, serial port, scanner, and/or the like. These and other input devices are connected to the processors 804 via input/output interfaces 840 that are coupled to the system bus 808, but may be connected by other interface and bus structures, such as a parallel port, game port, and/or a universal serial bus (USB).

A monitor 842 or other type of display device can be connected to the system bus 808 via an interface, such as a video adapter 844. In addition to the monitor 842, other output peripheral devices can include components such as speakers (not shown) and a printer 846 which can be connected to computing device 802 via the input/output interfaces 840.

Computing device 802 can operate in a networked environment using logical connections to one or more remote computers, such as a remote computing device 848. By way of example, the remote computing device 848 can be a personal computer, portable computer, a server, a router, a network computer, a peer device or other common network node, and the like. The remote computing device 848 is illustrated as a portable computer that can include many or all of the elements and features described herein relative to computing device 802.

Logical connections between computing device 802 and the remote computing device 848 are depicted as a local area network (LAN) 850 and a general wide area network (WAN) 852. Such networking environments are commonplace in offices, enterprise-wide computer networks, intranets, and the Internet. When implemented in a LAN networking environment, the computing device 802 is connected to a local network 850 via a network interface or adapter 854. When implemented in a WAN networking environment, the computing device 802 typically includes a modem 856 or other means for establishing communications over the wide area network 852. The modem 856, which can be internal or external to computing device 802, can be connected to the system bus 808 via the input/output interfaces 840 or other appropriate mechanisms. The illustrated network connections are exemplary and other means of establishing communication link(s) between the computing devices 802 and 848 can be utilized.

In a networked environment, such as that illustrated with computing environment 800, program modules depicted relative to the computing device 802, or portions thereof, may be stored in a remote memory storage device. By way of example, remote application programs 858 are maintained with a memory device of remote computing device 848. For purposes of illustration, application programs and other executable program components, such as the operating system 826, are illustrated herein as discrete blocks, although it is recognized that such programs and components reside at various times in different storage components of the computing device 802, and are executed by the processors 804 of the computing device.

Although embodiments of visual query have been described in language specific to structural features and/or methods, it is to be understood that the subject of the appended claims is not necessarily limited to the specific features or methods described. Rather, the specific features and methods are disclosed as exemplary implementations of visual query.

1. A visual query system, comprising:
query criteria for display as shapes that have a semantic relationship which represents logical associations between the query criteria;
a query statement generator configured to:
determine Boolean associations corresponding to the semantic relationship of the shapes;
generate a query statement for each shape of query criteria;
combine the query statements according to the Boolean associations; and
generate a query result of the combined query statements.

2. A visual query system as recited in claim 1, wherein the query statement generator is further configured to:
generate the query statements as a SQL query statement for each shape of query criteria; and
generate the query result from a SQL query of the combined SQL query statements.

3. A visual query system as recited in claim 1, wherein a first shape of query criteria is displayed proximate a second shape of query criteria such that the first shape has an AND Boolean association with the second shape.

4. A visual query system as recited in claim 1, wherein a first shape of query criteria is displayed proximate a second shape of query criteria within a visual query definition such that the first shape has an AND Boolean association with the second shape within the visual query definition.

5. A visual query system as recited in claim 1, wherein a first shape of query criteria is displayed proximate a second shape of query criteria within a visual query definition that is bordered to define a Boolean association between the first shape and the second shape within the visual query definition.

6. A visual query system as recited in claim 1, wherein a first set of query criteria are displayed within a first visual query definition, and wherein a second set of query criteria are displayed within a second visual query definition, the first set of query criteria including the second set of query criteria such that the second visual query definition is displayed within the first visual query definition.

7. A visual query system as recited in claim 1, wherein:
a first set of query criteria are displayed within a first visual query definition;
a second set of query criteria are displayed within a second visual query definition, the fist set of query criteria including the second set of query criteria such that the second visual query definition is displayed within the first visual query definition; and
the query statement generator is further configured to generate a first query result of the first set of query criteria and generate a second query result of the second set of query criteria such that the first query result and the second query result can be displayed as multiple query results.

8. A visual query system as recited in claim 1, wherein an additional shape of query criteria is configured for display with the query criteria, and wherein the query statement generator is further configured to:
determine an additional Boolean association corresponding to the semantic relationship of the additional shape of query criteria;
generate an additional query statement for the additional shape of query criteria;
combine the query statements and the additional query statement according to the additional Boolean association; and
update the query result of the combined query statements and the additional query statement.

9. A visual query system as recited in claim 1, further comprising data tables that maintain data criteria, and wherein the query criteria is displayed in user-identifiable terms as metadata that correlates to the data criteria maintained in the data tables.

10. A visual query system as recited in claim 1, further comprising a user interface configured to:
display criteria selections that include the query criteria within a criteria selection display on the user interface;
display the shapes of query criteria within a visual query definition on the user interface; and
display the query result within the visual query definition.

11. A visual query system as recited in claim 1, further comprising an audio output device configured to generate an audible indication corresponding to at least one of an update and a display of the query result.

12. A visual query system, comprising:
a visual query definition configured to associate query criteria in a display such that proximate positions of the query criteria define query criteria associations;
a query statement generator configured to:
determine a query statement association for each display relationship of the query criteria;
generate a query statement for each of the query criteria;
combine the query statements according to the query statement associations; and
generate a query result of the combined query statements for display in the visual query definition.

13. A visual query system as recited in claim 12, wherein the visual query definition is further configured to associate the query criteria in the display without logic operators connected between the query criteria.

14. A visual query system as recited in claim 12, wherein the query statement generator is further configured to determine the query statement associations as a Boolean association for each display relationship of the query criteria.

15. A visual query system as recited in claim 12, wherein the query statement generator is further configured to generate the query statements as a SQL query statement for each query criteria.

16. A visual query system as recited in claim 12, wherein a first query criteria is displayed proximate a second query criteria within the visual query definition such that the first query criteria has an AND query statement association with the second query criteria.

17. A visual query system as recited in claim 12, wherein a first query criteria is displayed proximate a second query criteria within the visual query definition such that the first query criteria has an OR query statement association with the second query criteria.

18. A visual query system as recited in claim 12, wherein the visual query definition is bordered to define a query statement association between a first query criteria displayed proximate a second query criteria within the visual query definition.

19. A visual query system as recited in claim 12, further comprising a second visual query definition configured to associate additional query criteria in the display, wherein:
the visual query definition includes the second visual query definition such that the second visual query definition is displayed within the visual query definition; and
the query statement generator is further configured to generate a second query result for the second visual query definition such that the query result and the second query result can be displayed as multiple query results.

20. A visual query system as recited in claim 12, wherein the visual query definition is further configured to associate additional query criteria in the display, and wherein the query statement generator is further configured to:
determine an additional query statement association for a display relationship of the additional query criteria;
generate an additional query statement for the additional query criteria;
combine the query statements and the additional query statement according to the additional query statement association; and
update the query result of the combined query statements and the additional query statements.

21. A visual query system as recited in claim 12, further comprising a user interface configured to:
display criteria selections that include the query criteria within a criteria selection display on the user interface;
display the query criteria within the visual query definition on the user interface; and
display the query result within the visual query definition on the user interface.

22. A visual query system as recited in claim 12, further comprising data tables that maintain data criteria, and wherein the query criteria is displayed in user-identifiable terms as metadata that correlates to the data criteria maintained in the data tables.

23. A visual query system as recited in claim 12, further comprising an audio output device configured to generate an audible indication corresponding to at least one of an update and a display of the query result.

24. A user interface, comprising:
a criteria selection display of query criteria;
a visual query definition displayed to associate the query criteria each represented by a shape displayed within the visual query definition; and
a query result displayed within the visual query definition, the query result generated from a combination of one or more query statements that each represent a shape of query criteria and the association of the query criteria.

25. A user interface as recited in claim 24, wherein the visual query definition is further displayed to associate the query criteria based on proximate positions of the query criteria in the visual query definition and without logic operators connected between the query criteria.

26. A user interface as recited in claim 24, wherein the query criteria are drag-and-drop query criteria from the criteria selection display to the visual query definition.

27. A user interface as recited in claim 24, wherein the visual query definition can be copied to create a second visual query definition for display on the user interface, and wherein the second visual query definition is redefined in an event that the visual query definition is redefined.

28. A user interface as recited in claim 24, wherein an attribute of the visual query definition defines a Boolean association of the query criteria represented by the shapes displayed within the visual query definition.

29. A user interface as recited in claim 24, wherein a color of the visual query definition defines a Boolean association of the query criteria represented by the shapes displayed within the visual query definition.

30. A user interface as recited in claim 24, wherein a border of the visual query definition defines a Boolean association of the query criteria represented by the shapes displayed within the visual query definition.

31. A user interface as recited in claim 24, wherein the one or more query statements are SQL query statements, and wherein the query result is generated from the combination of the one or more SQL query statements.

32. A user interface as recited in claim 24, wherein a first shape of query criteria is displayed proximate a second shape of query criteria within the visual query definition such that the first shape has an AND query statement association with the second shape.

33. A user interface as recited in claim 24, wherein a first shape of query criteria is displayed proximate a second shape of query criteria within the visual query definition such that the first shape has an OR query statement association with the second shape.

34. A user interface as recited in claim 24, further comprising additional query criteria not associated with the visual query definition and displayed to indicate the non-association.

35. A method, comprising:
displaying query criteria as shapes on a user interface;
determining a query statement association for each display relationship of the shapes of query criteria;
generating a query statement for each shape of query criteria; and
combining the query statements according to the query statement associations.

36. A method as recited in claim 35, wherein determining the query statement associations includes determining a Boolean association corresponding to each display relationship of the shapes of query criteria.

37. A method as recited in claim 35, wherein generating the query statements includes generating a SQL query statement for each shape of query criteria.

38. A method as recited in claim 35, further comprising displaying criteria selections that include the query criteria in a criteria selection display on the user interface.

39. A method as recited in claim 35, further comprising generating a query result of the combined query statements.

40. A method as recited in claim 35, further comprising displaying a query result of the combined query statements within a visual query definition that includes the shapes of query criteria.

41. A method as recited in claim 35, wherein displaying the query criteria as shapes includes displaying a first shape of query criteria proximate a second shape of query criteria within a visual query definition such that the first shape has a Boolean association with the second shape.

42. A method as recited in claim 35, wherein displaying the query criteria as shapes includes displaying a first shape of query criteria proximate a second shape of query criteria within a visual query definition such that the first shape has an AND Boolean association with the second shape.

43. A method as recited in claim 35, wherein displaying the query criteria as shapes includes displaying a first shape of query criteria proximate a second shape of query criteria within a visual query definition that is bordered to define an OR Boolean association between the first shape and the second shape.

44. A method as recited in claim 35, wherein displaying the query criteria includes displaying the query criteria in user-identifiable terms as metadata that correlates to data criteria maintained in data tables.

45. A method as recited in claim 35, wherein displaying the query criteria includes displaying a first set of query criteria within a first visual query definition, and displaying a second set of query criteria within a second visual query definition such that the first set of query criteria includes the second set of query criteria.

46. A method as recited in claim 35, further comprising:
adding additional query criteria as a shape on the user interface;
determining an additional query statement association for a display relationship of the additional shape of query criteria;
generating an additional query statement corresponding to the additional shape of query criteria;
combining the query statements and the additional query statement according to the additional query statement association; and
updating a query result displayed on the user interface to include the additional query criteria.

47. A method as recited in claim 46, wherein adding the additional query criteria includes dragging-and-dropping the additional query criteria on the user interface.

48. A method as recited in claim 35, further comprising generating an audible indication corresponding to at least one of a display of a query result on the user interface and an update of a query result displayed on the user interface.

49. One or more computer readable media comprising computer executable instructions that, when executed, direct a computing device to perform the method of claim 35.

50. One or more computer readable media comprising computer executable instructions that, when executed, direct a computing device to:
display a visual query definition to associate query criteria as shapes having display relationships;
determine a query statement association for each shape of query criteria according to the display relationships;
generate a query statement for each shape of query criteria;
combine the query statements according to the query statement associations; and
generate a query result of the combined query statements for display in the visual query definition.

51. One or more computer readable media as recited in claim 50, further comprising computer executable instructions that, when executed, direct the computing device to determine the query statement association for each shape of query criteria as a Boolean association.

52. One or more computer readable media as recited in claim 50, further comprising computer executable instructions that, when executed, direct the computing device to generate the query statement for each shape of query criteria as a SQL query statement.

53. One or more computer readable media as recited in claim 50, further comprising computer executable instructions that, when executed, direct the computing device to display criteria selections that can be added to the visual query definition.

54. One or more computer readable media as recited in claim 50, further comprising computer executable instructions that, when executed, direct the computing device to display a first shape of query criteria proximate a second shape of query criteria within the visual query definition such that the first shape has a Boolean association with the second shape.

55. One or more computer readable media as recited in claim 50, further comprising computer executable instructions that, when executed, direct the computing device to display a first shape of query criteria proximate a second shape of query criteria within the visual query definition such that the first shape has an AND Boolean association with the second shape.

56. One or more computer readable media as recited in claim 50, further comprising computer executable instructions that, when executed, direct the computing device to display a first shape of query criteria proximate a second shape of query criteria within the visual query definition that is bordered to define an OR Boolean association between the first shape and the second shape.

57. One or more computer readable media as recited in claim 50, further comprising computer executable instructions that, when executed, direct the computing device to display a first set of query criteria within the visual query definition, and display a second set of query criteria within a second visual query definition such that the visual query definition includes the first set of query criteria and the second set of query criteria.

58. One or more computer readable media as recited in claim 50, further comprising computer executable instructions that, when executed, direct the computing device to generate an audible indication corresponding to an update of the query result displayed within the visual query definition.
